(19) United States
(12) Patent Application Publication
(10) Pub. No.: US 2014/0040150 A1
(43) Pub. Date: Feb. 6, 2014

(54) LOG-IN METHOD FOR PRODUCT AND APPLICATION PROGRAM THEREOF

(71) Applicant: Hung-Wei CHEN, Taichung City (TW)

(72) Inventor: Hung-Wei CHEN, Taichung City (TW)

(21) Appl. No.: 13/957,789

(22) Filed: Aug. 2, 2013

(30) Foreign Application Priority Data
Aug. 6, 2012 (TW) 101128320
Jul. 18, 2013 (TW) 102125673

(51) Int. Cl. G06Q 30/00

(52) U.S. Cl. CPC G06Q 30/012
USPC 705/302

(57) ABSTRACT

A log-in method for a product and an application program thereof applies to a mobile device in order to execute the application program, the application program connects with a community website and executes a check-in procedure on the community website. When the check-in procedure is being executed, the application program obtains the product information and the sales information both related to the product and automatically fills out the information in an executing page having a check-in function. Hence, a sales end server defines check-in information, including a check-in landmark, check-in contents, a check-in time, a check-in name, etc., as the log-in information of the product, so as to execute the log-in activity of the product.

### BACKGROUND OF THE INVENTION

1. Field of the Invention

The present invention generally relates to a log-in method for a product, more particularly to a method that obtains the installing location and the registration time of a product for the log-in through a check-in procedure of a community website, and simultaneously promotes the product via the check-in procedure in order to exchange a corresponding preference or compensation.

2. Description of the Related Art

When consumers purchase merchandise, as electronic products, the most concern is about warranty period. If a product is damaged by non-human factors within a warranty period, the manufacturer may provide a free service to repair the damaged product or to exchange a new one.

Generally speaking, a product shall be logged in firstly and the warranty of the product may then be effective. Hence, after a user purchasing a product, the user may personally complete the log-in activity of the product in order to activate the warranty. For example, the user should connects with the official website of the product manufacturer to input some product information for completing the log-in activity and activating the warranty. Continuously, the user must fills out a warranty card or a replied letter attached in the product and re-send to the original manufacturer, then the original manufacturer just can login and activate the warranty of the product. As aforesaid, the way to log-in and activating warranty is inconvenient, so that many users are not willing to do these procedures so as to cause their rights damaged.

Accordingly, lots of manufacturers start to think about new ways to log-in and activating warranty in order to make users simply complete log-in procedures; moreover, products may also be promoted through log-in activities.

### SUMMARY OF THE INVENTION

The main objective of the present invention is to provide a log-in method for a product and an application program thereof. That is, through a purchaser finishing a check-in procedure on a community website, then the login of a product is directly completed so as to build up the log-in information that is more complete.

The other objective of the present invention is to provide a log-in method for a product and an application program thereof. That is, through the check-in procedure, the information of the product is published on the community website so as to promote the product, and a sales end for the product provides a corresponding preference as compensation to the purchaser.

To approach above objectives, the present invention applies a mobile device to execute an application program. The application program connects with and logins the community website in order to execute the check-in procedure. When the check-in is being processed, the application program obtains product information and sales information corresponding to the product from a sales end server, and automatically fills out an executing page having a check-in service. Simultaneously, the application program withdraws the plural kinds of check-in information and replies to the sales end server. Therefore, the sales end server is able to define those kinds of check-in information, as a check-in landmark, check-in contents, a check-in time, and a check-in name, in the mobile device as the log-in information of the product in order to execute the log-in activity of the product.

Compared to related arts, the effect of the present invention is described as following. The purchaser is capable of automatically completing the log-in activity of a product via an application program without personally going to the website of a sales end, inputting the product information for the log-in, manually writing a warranty card, or re-sending a replied letter to a sales end.

Further, the present invention may reply the check-in information to the sales end so as to let the sales end obtain the information as an installing location and a registration time of the product. Therefore, while the product is in log-in, the sales end can define above information as the log-in information of the product for more complete. And, when the purchaser is executing the check-in procedure on the community website, the relative sales information of the product can be defined as the check-in contents, and the check-in contents are posted on the community website, so that a free promotion is brought to the sales end. More, the sales end is able to provide a corresponding preference to the purchaser who helps to promote the product.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic system structural view of a preferred embodiment of the present invention;

FIG. 2 illustrates a check-in flow chart of the preferred embodiment of the present invention;

FIG. 3 illustrates a flow chart of installing an application program of the preferred embodiment of the present invention;

FIG. 4 illustrates a schematic view of a QR code of the preferred embodiment of the present invention;

FIG. 5 illustrates a flow chart of capturing information of the preferred embodiment of the present invention; and

FIG. 6 illustrates a flow chart of a check-in procedure of the preferred embodiment of the present invention;

FIG. 7 illustrates a schematic view of an executing page of the check-in procedure of the preferred embodiment of the present invention;

FIG. 8 illustrates a schematic view of a check-in screen of the preferred embodiment of the present invention; and

FIG. 9 illustrates a log-in flow chart of the preferred embodiment of the present invention.

### DETAILED DESCRIPTION OF THE INVENTION

Following preferred embodiments and figures will be described in detail so as to achieve aforesaid objects.

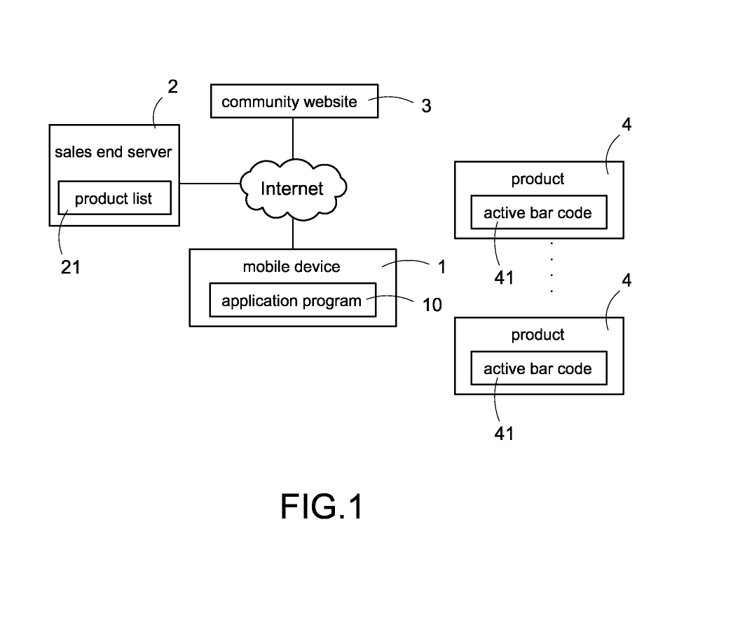

Please refer to FIG. 1, which illustrates a schematic system structural view of a preferred embodiment of the present invention. The present invention mainly provides a log-in method for a product. That is, a purchaser is able to complete a log-in activity of a product 4 through simple procedures after the purchaser orders the product 4. Simultaneously, through a check-in procedure, the product 4 is on sale as well, and therefore the relative promotions fed back from a sales end of the product 4 can be exchanged. The present invention is mainly applied to a mobile device 1. The mobile device 1 connects with a sales end server 2 of the sales end of the product 4 through the Internet and connects with at least one community website 3, as Facebook, Google Plus, etc.

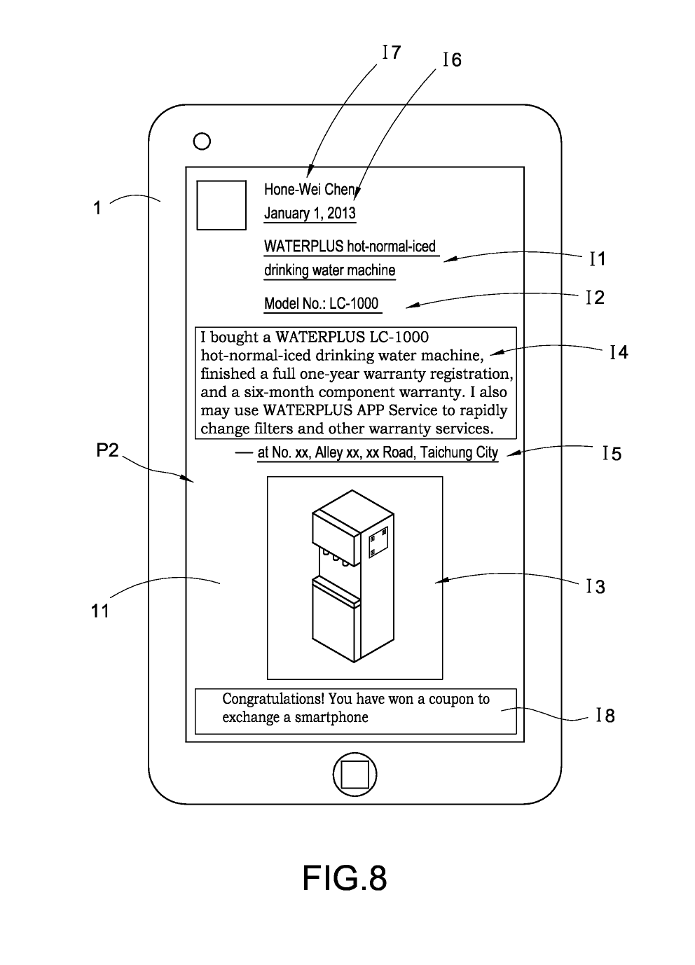

The present invention mainly executes an application program 10 via the mobile device 1. Thus, because of the application program 10, the mobile device 1 is able to automatically connect with the community website 3 and executes a check-in procedure. Generally speaking, when executing the check-in procedure on the community website, a user may input and edit the contents on his own demands, as inputting words, uploading photos, choosing a check-in landmark, etc., for example, a check-in name I7 and a check-in time I6, shown in FIG. 8. The check-in name 17 is the ID or number of the user of the mobile device 1 registered on the community website 3, and the check-in time I6 is the spending time to execute the check-in procedure.

The main characteristic of the present invention is that the product information and the sales information of the product 4 are the input contents so as to create the chance to expose the product 4 on the community website 3 through the check-in activity of the purchaser. Further, through check-in information as aforesaid edited contents, check-in landmark, check-in name I7, check-in time I6, etc. produced by the check-in procedure, the relative information of the product 4 can be obtained, and thus a log-in activity for the product 4 can be executed, wherein the check-in name I7 is the ID or number of the user registered on the community website 3.

There is one thing to be noted. Current community websites have the function similar to check-in. For example, a position register procedure provided by Google Plus is similar to the check-in procedure provided by Facebook. In practice, aforesaid check-in procedure and position register procedure both provide the function for users inputting words or uploading photos on community websites or letting good friends on community websites know their recent conditions through landmarks chosen by the users and check-in time points automatically produced by the procedures. For the embodiment, the check-in procedure provided by Facebook is used as an example. More, any procedure able to approach the same objective or function as aforesaid position register procedure may be in the scope of the claims of the present invention.

For a purchaser, through the check-in procedure to log in a product is able to avoid the inconveniences that of manually connecting with a sales end website and inputting the product information on his own to log in, handily filling out a warranty card, or re-sending a replied letter to a sales end. At the same time, the sales end mainly provides the purchaser relative benefits or compensations, as the verified procedure of warranty, expanding warranty of the product 4, gifts, etc., so as to attract the purchaser to log in the product by means of the method of the present invention. Hence, the sales end creates more chances to expose the product 4 on the community website 3. The purchaser may easily log in the product and obtain benefits or compensations from the sales end. It is a truly win-win situation.

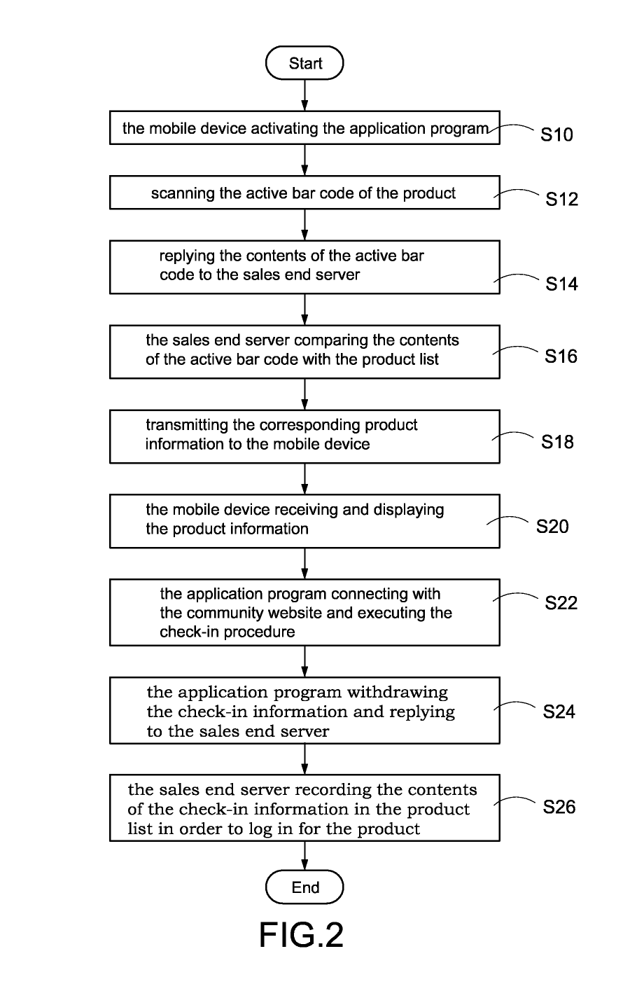

With reference to FIG. 2, which illustrates a check-in flow chart of the preferred embodiment of the present invention. The method of the present invention has the steps of:

(S10) the mobile device 1 executing the application program 10 installed therein;

(S12) the application program 10 controlling and activating a capturing unit 12, as shown in FIG. 4, of the mobile device 1 and scanning an active bar code 41 stuck on the body, inner portion or outer portion of the box of the product 4;

(S14) the application program 10 replying the contents of the active bar code 41 to the sales end server 2, wherein the contents of the active bar code 41 are as 1T1300001, for example;

(S16) after the sales end server 2 receiving the contents of the active bar code 41, the sales end server 2 obtaining corresponding sales information of the product 4 according to the contents of the active bar code 41, in practice, the sales end server 2 comparing the contents of the active bar code 41 with a product list 21;

(S18) after succeeding the comparison, the sales end server 2 capturing product information corresponding to the contents of the active bar code 41 from the product list 21 and transmitting the corresponding product information to the mobile device 1; and

(S20) the mobile device 1 receiving the product information via the application program 10 and displaying the product information on a display, as shown a display 11 in FIG. 4.

For the embodiment, each product 4 sold by the sales end may attach an active bar code 41. A Barcode is an example for the embodiment, but the active bar code 41 may be a QR code as well, and it is not limited thereto. Before the product 4 being sold, the sales end may register the contents of the active bar code 41, and the corresponding product information, the corresponding sales information, etc. of the contents of the active bar code 41 of the product 4. Therefore, after the sales end server 2 receives the contents of the active bar code 41 transmitted by the application program 10, the sales end server 2 may obtain the product information and the sales information corresponding to the contents of the active bar code 41. An example of the product list 21 is as following:

| | |
|---|---|
| Product Photo | |
| Contents of bar code | 1T1300001 |
| Product name | WATERPLUS hot-normal-iced drinking water |
| | machine |
| Product model | LC-1000 |
| number | |
| Sales information | I bought a WATERPLUS LC-1000 hot-normal-iced |
| | drinking water machine, finished a full one-year |
| | warranty registration, and a six-month component |
| | warranty. I also may use WATERPLUS APP |
| | Service to rapidly change filters and other |
| | warranty services. |
| Lottery information | Congratulations! You have won a coupon to |
| | exchange a smartphone. |
| Check-in landmark | |
| Check-in contents | |
| Warranty expiration | |
| date | |
| Registration time | |

As shown above, the product list 21 mainly has contents of bar code, product photo, product name, product model number, sales information, lottery information, check-in landmark, check-in contents, warranty expiration date, and registration time. The contents of bar code, product photo, product name, product model number, sales information, and lottery information are registered in the product list 21 as soon as the active bar code 41 is produced. Hence, when the application program 10 scans the active bar code 41 and replies the contents of the active bar code 41, the sales end server 2 obtains the product photo, product name, product model name, sales information, etc. corresponding to the contents of the bar code of the product 4 according to the contents of the bar code, and replies to the mobile device 1. More especially, the sales end server 2 simultaneously obtains the lottery information corresponding to the contents of the bar code of the product 4, and replies to the mobile device 1 (detailed may be described later). In addition to aforesaid product photo, product name, product model number, etc., others as product website link information, product comments, etc. are involved as well, but it is not limited thereto.

It is to be noted that the lottery information also has an item of point-set activity, wherein the method of setting point is linked to another point-set data base, not shown in figure. The point-set data base provides calculations of consumers obtaining points, and help consumers to exchange awards based on points to consumers.

After step (S20), other steps are of:

(S22) the application program 10 automatically connecting with a community website 3 and executing a check-in procedure, the product information then being defined as the input contents of the check-in procedure;

(S24) the application program 10 withdrawing all check-in information and replying to the sales end server 2 at the moment of the check-in procedure being executed, wherein the check-in information is defined as all information of a check-in screen for the embodiment, but it is not limited thereto;

(S26) the sales end server 2 recording the contents of the check-in information in the product list 21 in order to log in for the product 4, in practice, the sales end server 2 obtaining demanded information, as the check-in name, the check-in time, the check-in landmark, etc., from the check-in information in order to fill out the corresponding fields of the product list 21, so that the log-in information of the product is more complete.

There is one thing to be noted, that is, the safety and personal information leakage of a user may be protected. Before the application program 10 withdrawing and transmitting the check-in information, a warning window shall be shown on the mobile device 1 so as to remind the user the check-in information will be transmitted to outside. After the user confirming and agreeing with, the check-in information can then be sent out.

As aforesaid, to execute the method of the present invention, the application program 10 should be installed in the mobile device 1. For the embodiment, the application program 10 is developed by the producer or sales end thereof. More, the application program 10 is able to add other functions, for example, the user is able to scan or input the machine number of the product and reply so as to simply make a phone call for repair, investigate consumer comments, etc.

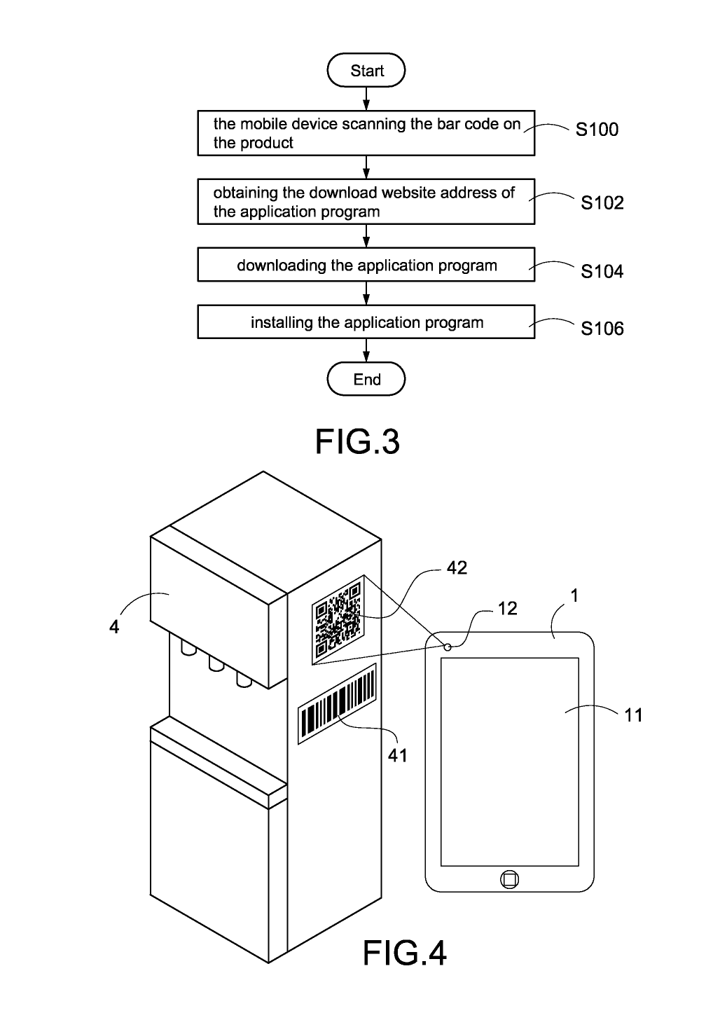

Please refer to FIG. 3 and FIG. 4, which illustrate a flow chart of installing an application program of the preferred embodiment of the present invention and a schematic view of a QR code of the preferred embodiment of the present invention. As shown in FIG. 4, in addition to the active bar code 41, the sales end is capable of selling the product 4 and simultaneously sticking a download bar code 42 on the product 4, the download bar code 42 records a download website address of the application program 10. For the embodiment, the download bar code 42 is a QR code, but it is not limited thereto. When a purchaser purchases the product 4 and wants to download the application program 10, the purchaser only uses the capturing unit 12, as camera, of the mobile device 1 to scan the download bar code 42 so as to easily link to the download website for installing the application program 10. Aforesaid is to let a purchaser conveniently download the application program 10 after purchasing the product 4. However, the purchaser is also able to login a system market platform, as Google Play or Apple Store, and download the application program 10 via the mobile device 1.

Please refer to FIG. 3, the steps of installing the application program 10 has the steps of:

(S100) scanning the download bar code 42 on the product 4 via the capturing unit 12 of the mobile device 1;

(S102) the mobile device 1 obtaining the download website address of the application program 10 from the download bar code 42;

(S104) the mobile device 1 automatically connecting with the download website address and downloading the application program 10; and

(S106) the mobile device 1 being installed the application program 10 after downloading.

After step (S106), the purchaser may operate the mobile device 1 to activate the capturing unit 12 via the application program 10, and scan the active bar code 41 via the capturing unit 12 in order to execute the method of the present invention.

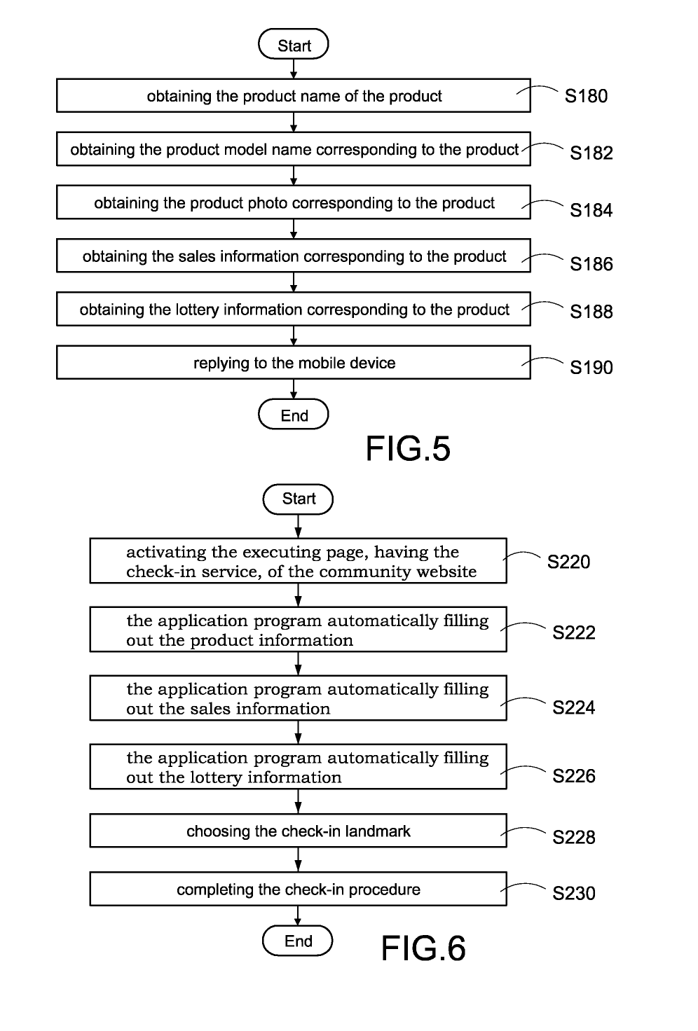

Please refer to FIG. 5, which illustrates a flow chart of capturing information of the preferred embodiment of the present invention. As aforesaid (S18), the steps of capturing information has the steps of:

(S180) the sales end server 2 comparing the contents of the bar code 41 received by the sales end server 2 with the product list 21, the sales end server 2 obtaining the product name of the product 4 corresponding to the field of the product list 21;

(S182) the sales end server 2 obtaining the product model name corresponding to the product 4;

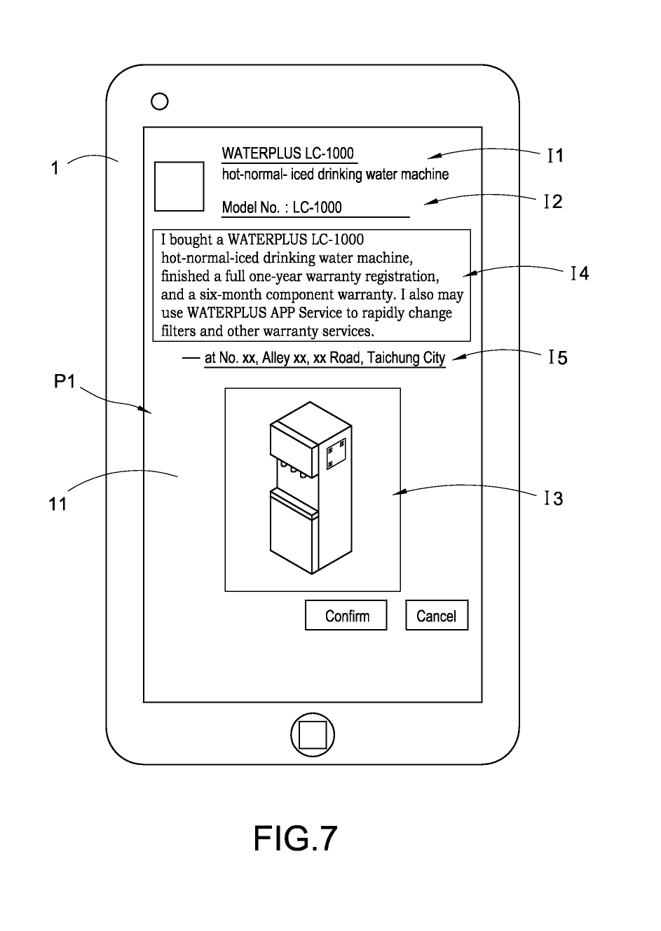

(S184) the sales end server 2 obtaining the product photo corresponding to the product 4, in other words, the product information of the present invention mainly has the product name, product model number and product photo, as a product name I1, a product model number I2 and a product photo I3 shown in FIG. 7, but it is not limited thereto;

(S186) the sales end server 2 further obtaining the sales information corresponding to the product 4 according to the real recording contents of the product list 21;

(S188) the sales end server 2 obtaining the lottery information corresponding to the product 4, as shown in FIG. 8, a completed check-in screen P2 further has the sales information I4 and the lottery information I8 that corresponds to the product 4; and

(S190) the sales end server 2 replying the obtained product information, sales information and lottery information back to the mobile device.

There is one thing to be noted. That is, the sales information I4 is defined as the sales words published on the community website 3 by the sales end of the product 4, wherein the sales words further has the words to attract other users to purchase the product 4 or to use the method of the present invention. The lottery information I8 is defined as a prize that is set as soon as the active bar code 41 is produced. After the purchaser completes the check-in procedure (completing log-in), the lottery information I8 is then shown on the check-in screen P2 (the web page of the community website 3), and the purchaser may know whether a prize is awarded. In other words, different active bar codes 41 may be offered different kinds of lottery information I8. As it can be seen, once a purchaser orders different products 4, different kinds of lottery information I8 (shown on the check-in screen P2) may be gotten after the check-in procedures are completed.

Please refer to FIG. 6, which illustrates a flow chart of a check-in procedure of the preferred embodiment of the present invention. As aforesaid step (S22), the application program 10 directs the mobile device 1 to connect with the community website 3 for executing the check-in procedure and defines the information as the input contents of the check-in procedure after having the product information, sales information and lottery information.

There is one thing to be noted. That is, if the community website 3 authorizes that the application program 10 directly connects with and uses the check-in function, the mobile device 1 directly uses the check-in function provided by the community website 3 to choose the check-in landmark for completing the check-in procedure via the application program 10. However, some community websites 3 may not offer the check-in function, or do provide the check-in function but do not authorize that the application program 10 directly connects with the check-in function. Accordingly, the present invention provides another embodiment to help a user for executing the check-in procedure.

For example, the sales end server 2 can add one landmark-choosing field to the product list 21 or other lists (not shown in figure), and record one or more landmarks chosen by a user in the landmark-choosing field. During a user operating the method of the present invention, via the sales end server 2, a landmark can be chosen, or the user himself sets a landmark and records the landmark in the sales end server 2. Hence, the self-set landmark, the product information, the sales information, the lottery information, etc. are published on the community website 3. Therefore, the web page of the community website 3 presents the self-set landmark information simultaneously, and the user is able to use the check-in function provided by the community website 3 in order to approach the effect of check-in. Aforesaid is only a preferred embodiment of the present invention, but it is not limited thereto.

The practical flow chart in FIG. 6 is described as following. The flow chart has the steps of:

(S220) the application program 10 activating the community website 3, more practically, the application program 10 directly connecting with and activating an executing page, having a check-in service, of the community website 3, wherein the executing page is as an executing page P1 in FIG. 7;

(S222) the application program 10 automatically filling out the received product information on the executing page P1;

(S224) the application program 10 automatically filling out the received sales information I4 on the executing page P1, so that the sales information I4 can be defined as the input contents of the check-in procedure;

(S226) if the application program 10 receiving the lottery information I8, the application program 10 filling out the lottery information I8 on the executing page P1, and simultaneously defining the lottery information I8 as part of the input contents;

(S228) the user manually choosing a check-in landmark I5, or the application program 10 automatically choosing a check-in landmark I5 based on a GPS positioning, through a self-set serial connecting map, the application program 10 can be positioned, or through a map serially connecting with the community website 3, the application program 10 can be positioned as well, but it is not limited thereto; and

(S230) completing the check-in procedure according to the product information, the sales information I4, the lottery information I8, the check-in landmark I5, and other kinds of information that are the check-in name I7, the check-in time I6, etc. and are automatically generated by the system.

There is one thing to be noted, that is, step (S222) to step (S228) are the steps to input different kinds of information into the executing page P1, but the sequence of inputting those kinds of information may be varied. In other words, there is no a certain sequence to execute step (S222) to step (S228), and aforesaid sequence may not limit thereto.

Please refer to FIG. 7, which illustrates a schematic view of the executing page of the check-in procedure of the preferred embodiment of the present invention. As shown in figure, when the application program 10 directs the mobile device 1 to connect with the executing page P1 of the check-in procedure, the application program 10 may automatically input the product information, as the product name I1, the product model number I2 and the product photo I3, the sales information I4 and the check-in landmark I5. Further, even though the application program 10 does receive the lottery information I8 and automatically fills in for the lottery information I8, but another factor is to let the user be surprised for a lottery, the user may not see the lottery information I8 on the executing page P1. For the embodiment, the lottery information I8 is shown on the check-in screen P2 after completing the check-in procedure, so that the user just know whether he wins or not. However, aforesaid is just a preferred embodiment of the present invention, but it is not limited thereto.

After completing the check-in procedure, the friends of the purchaser may have the check-in message on the community website 3. In other words, the product name I1, the product model number I2, the product photo I3, the sales information I4, and the lottery information I8 of the product 4 will be seen. From the point of the sales end, a chance to promote the product 4 on the community website 3 is gotten, and as the contents of the sales information I4, not only the purchaser easily completes to login the product via the check-in procedure, but also the purchaser obtains relative benefits or compensations. The embodiment takes the expansion of a full six-month component warranty as an example. More, if the product 4 is promoted in conjunction with a lottery activity, the purchaser may additionally obtain other prizes, that is, the contents of the lottery information I8 are shown as aforesaid.

Obviously, the method of the present invention is to let the application program 10 direct and connect with the community website 3, and inquire about and receive the plural kinds of information I1-I4, and then automatically fill in the executing page P1. That is, even though the contents of the kinds of information I1-I4 are a lot, the user may not manually input the information, therefore to input information will be finished rapidly, and the user may be willing to come back for another purchase.

Please refer to FIG. 8, which illustrates a schematic view of a check-in screen of the preferred embodiment of the present invention. After the check-in procedure is completed, the check-in screen is then shown on the community website 3, and has the plural kinds of check-in information. For the preferred embodiment, the application program 10 is capable of replying the plural kinds of check-in information to the sales end server 2 for log-in.

As shown in FIG. 8, the check-in information mainly has the product name I1, the product model number I2, the product photo I3, the sales information I4, the check-in landmark I5, the check-in time I6, the check-in name I7, and the lottery information I8 of the product 4. The application program 10 can reply all or part of the check-in information to the sales end server 2. After receiving the check-in information, the sales end server 2 not only defines the check-in landmark I5 as an installing location of the product 4, but also defines the check-in time I6 as a registration time of the product 4, so that the log-in information of the product is more complete. Additionally, the purchaser can execute the check-in procedure, and simultaneously can input other information manually, further that, the input other information can be part of the check-in information and can be replied to the sales end server 2 for store.

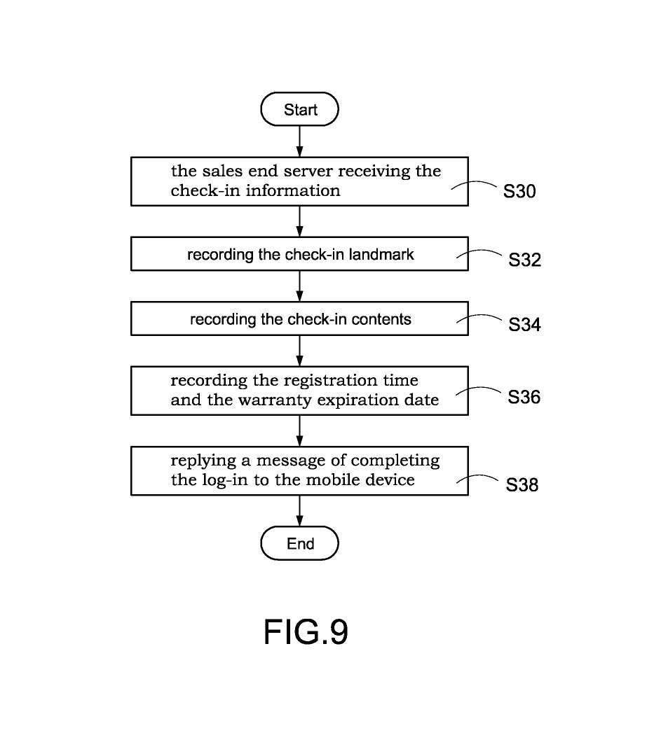

Please refer to FIG. 9, which illustrates a log-in flow chart of the preferred embodiment of the present invention. After step (S26), other steps are of:

(S30) the sales end server 2 receiving the check-in information transmitted from the mobile device 1, wherein the check-in information mainly has the check-in landmark I5, the check-in contents, as the check-in name I7, the words manually input by user, etc., the check-in time I6, etc.;

(S32) the sales end server 2 recording the check-in landmark I5 in the product list 21;

(S34) the sales end server 2 further recording the check-in contents in the product list; and

(S36) more, the sales end server 2 defining the check-in time I6 as the registration time and recording in the product list 21, at the same moment, the sales end server 2 calculating a new warranty expiration date of the product 4 based on the original warranty period and a preferential warranty period, and then recording in the product list 21, wherein the sales end server 2 can define the check-in time as a judgment standard to determine the registration time, but it is not limited thereto, the method for the sales end server 2 determining the registration time being not limited thereto;

(S38) the sales end server 2 confirming the completion of the log-in and replying a message of completing the log-in to the mobile device 1 after the fields of the product list 21 of the product 4 being filled out, hence the completion of the log-in procedure of the product 4 being transmitted to the user.

In addition, the sales end server 2 is able to reply above message to other platforms of the user via other means, and the mobile device 1 is not limited thereto. For example, either e-mail or text message is the means to reply to an e-mail box or a mobile phone of the user, but aforesaid is not limited thereto. More, the sales end server 2 records the prize that is obtained by the user participating a lottery activity in the message in order to define the contents of the lottery information I8 as a lottery evidence, or, when the user exchanges a prize, the active bar code 41 of the product 4 is an evidence as well, but it is not limited thereto.

For the embodiment, the purchaser purchases the same product 4, as a drinking water machine, and completes the check-in procedure to login the product 4, then the purchaser gains an expanded six-month component warranty, namely the same check-in preference. However, each active bar code 41 stuck on each product 4 is exclusive, so each prize from the lottery activity is exclusive as well after completing the check-in procedure, that is to say the contents of each kind of lottery information are individual also. For instance, if the contents to the active bar code 41 stuck on the product 4 purchased by a user are “1T1300001”, thus a lottery information showing “The first prize: a coupon to exchange a smartphone” will be sent to the user after the check-in; on the other hand, if the contents of the active bar code 41 are “1T1300002”, then a lottery information showing “Not winning” will be sent to the user after the check-in. The log-in method of the present invention is basically executed by the application program 10 of the mobile device 1. The application program 10 stores a executable code that is executed by the mobile device 1. Hence, when the mobile device 1 downloads the application program 10 and executes, the mobile device 1 thus can executes the log-in method of the product 4 of the present invention.

In practice, the mobile device 1 executes following steps according to the application program 10 in order to complete the log-in method of the present invention, and the steps are of:

(a) activating capturing unit 12 of the mobile device 1, and scanning the active bar code 41, wherein the active bar code 41 corresponds to the product 4;

(b) transmitting the contents of the active bar code 41 to a sales end server 2;

(c) receiving corresponding product information and corresponding sales information I4 obtained and replied by the sales end server 2 according to the contents of the active bar code 41, wherein the product information has the product name I1, the product model number I2 and the product photo I3 that correspond to the product 4;

(d) connecting with and logging in the community website 3 and executing the check-in procedure on the community website 3, the product information and the sales information I4 then being defined as the input contents of the check-in procedure;

(e) choosing the check-in landmark I5 in order to finish the check-in procedure; and

(f) transmitting check-in information which is completed to the sales end server 2 in order to let the sales end server 2 execute the log-in activity of the product 4 according to the check-in information.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A log-in method for a product applied to a mobile device (1) comprising the steps of:
(a) the mobile device (1) executing an application program (10);
(b) the application program (10) activating a capturing unit (12) of the mobile device (1) and scanning an active bar code (41), wherein the active bar code (41) corresponds to a product (4);
(c) transmitting the contents of the active bar code (41) to a sales end server (2);
(d) the sales end server (2) obtaining corresponding product information according to the contents of the active bar code (41);
(e) transmitting the product information to the application program (10);
(f) the application program (10) connecting with a community website (3) and executing a check-in procedure on the community website (3), the product information then being defined as the input contents of the check-in procedure;
(g) choosing a check-in landmark (15) in order to finish the check-in procedure; and
(h) transmitting check-in information which is completed to the sales end server (2) in order to let the sales end server (2) execute the log-in activity of the product (4) according to the check-in information.

2. The log-in method for a product according to claim 1, wherein the sales end server (2) has a product list (21), the product list (21) recording the contents of the active bar code (41) and the product information corresponding to the contents of the active bar code (41), in step (d), the sales end server (2) comparing the contents of the active bar code (41) to the product list so as to obtain the corresponding product information according to a comparing result.

3. The log-in method for a product according to claim 2, wherein the product information has a product photo (I3), a product name (I1) and a product model number (I2).

4. The log-in method for a product according to claim 2, wherein step (h) comprises the steps of:
(h1) the sales end server (2) obtaining the check-in landmark (15) of the check-in information and recording the check-in landmark (15) into the corresponding fields of the product list (21);
(h2) the sales end server (2) obtaining the check-in contents of the check-in information and recording the check-in contents into the corresponding fields of the product list (21), wherein the check-in contents comprise at least one check-in name (17);
(h3) the sales end server (2) obtaining the check-in time (16) of the check-in information, the check-in time (16) being as a registration time of the product (4), the sales end server (2) recording the registration time into the corresponding field of the product list (21); and
(h4) calculating the warranty expiration date of the product (4) according to the registration time and the warranty period of the product (4), and recording the warranty expiration date into the corresponding field of the product list (21).

5. The log-in method for a product according to claim 2 further comprising the step of:
(i) the sales end server (2) obtaining corresponding sales information (I4) according to the contents of the active bar code (41);
wherein in step (e), the sales end server (2) simultaneously transmits the sales information (I4) to the application program (10), and in step (f), the application program (10) simultaneously defines the sales information (I4) as the input contents of the check-in procedure.

6. The log-in method for a product according to claim 2 further comprising the step of:
(j) the sales end server (2) obtaining corresponding lottery information (I8) according to the contents of the active bar code (41);
wherein in step (e), the sales end server (2) simultaneously transmits the lottery information (I8) to the application program (10), and in step (f), the application program (10) simultaneously defines the lottery information (I8) as the input contents of the check-in procedure.

7. The log-in method for a product according to claim 6, wherein after step (h), a step is of:
(k) the sales end server (2) replying a login-complete message to the mobile device (1), wherein the login-complete message records the contents of the lottery information (I8) in order to define the contents of the lottery information (I8) as a lottery evidence.

8. The log-in method for a product according to claim 2, wherein the product (4) is stuck a download bar code (42) and the further steps before step (a) are of:
(a01) the mobile device (1) scanning the download bar code (42) in order to obtain a download website address of the application program (10);
(a02) connecting with the download website address to download the application program (10); and
(a03) installing the application program (10).

9. The log-in method for a product according to claim 8, wherein the active bar code (41) is a Barcode and the download bar code is a QR code.

10. An application program (10) stored in a mobile device (1), the application program (10) recording an executable code of the mobile device (1), the mobile device (1) being installed the application program (10) and executing a log-in method for a product (4), the log-in method comprising the steps of:
(a) activating a capturing unit (12) of the mobile device (1), and scanning an active bar code (41), wherein the active bar code (41) corresponds to the product (4);
(b) transmitting the contents of the active bar code (41) to a sales end server (2);
(c) receiving corresponding product information and corresponding sales information (I4) obtained and replied by the sales end server (2) according to the contents of the active bar code (41), wherein the product information comprises a product name (I1), a product model number (I2) and a product photo (I3) that correspond to the product (4);
(d) connecting with and logging in a community website (3) and executing a check-in procedure on the community website (3), the product information and the sales information (I4) then being defined as the input contents of the check-in procedure;
(e) choosing a check-in landmark (I5) in order to finish the check-in procedure; and
(f) transmitting check-in information which is completed to the sales end server (2) in order to let the sales end server (2) execute the log-in activity of the product (4) according to the check-in information.
